(19) United States
(12) Patent Application Publication
(10) Pub. No.: US 2020/0184059 A1
(43) Pub. Date: Jun. 11, 2020

(54) FACE UNLOCKING METHOD AND APPARATUS, AND STORAGE MEDIUM

(71) Applicant: BEIJING SENSETIME TECHNOLOGY DEVELOPMENT CO., LTD., Beijing (CN)

(72) Inventors: Liwei WU, Beijing (CN); Xiao JIN, Beijing (CN); Hongwei QIN, Beijing (CN); Rui ZHANG, Beijing (CN); Tianpeng BAO, Beijing (CN); Guanglu SONG, Beijing (CN); Xin SU, Beijing (CN); Junjie YAN, Beijing (CN)

(73) Assignee: BEIJING SENSETIME TECHNOLOGY DEVELOPMENT CO., LTD., Beijing (CN)

(21) Appl. No.: 16/790,703

(22) Filed: Feb. 13, 2020

Related U.S. Application Data
(63) Continuation of application No. PCT/CN2018/104408, filed on Sep. 6, 2018.

(30) Foreign Application Priority Data
Sep. 7, 2017 (CN) 201710802146.1

(51) Int. Cl. G06F 21/32; G06K 9/00; G06T 5/00

(52) U.S. Cl. CPC G06F 21/32; G06T 5/009; G06K 9/00275; G06K 9/00255

(57) ABSTRACT

A face unlocking method includes: performing face detection on one or more images; performing face feature extraction on an image in which a face is detected; performing authentication on extracted face features based on stored face features, wherein the stored face features at least comprise face features of face images of at least two different angles corresponding to a same identity (ID); and performing an unlocking operation at least in response to the extracted face features passing the authentication.

### CROSS-REFERENCE TO RELATED APPLICATIONS

This is a continuation of International Patent Application No. PCT/CN2018/104408 filed on Sep. 6, 2018, which claims priority to Chinese Patent Application No. 201710802146.1 filed on Sep. 7, 2017. The disclosure of these applications are hereby incorporated by reference in their entirety.

### TECHNICAL FIELD

The present disclosure relates to an artificial intelligence technology, and in particular, to a face unlocking method and apparatus, a face unlocking information registration method, a device, a program, and a medium.

### BACKGROUND

In the information age, various terminal applications (APPs) emerge in endlessly. When using the various applications, each user needs to register user information to retain and protect user data. In addition, with the development of Internet technology, terminal devices can provide users with more and more functions, such as communication, photo storage, installation of various applications, etc., and many users lock their terminal devices to prevent user data therein from leakage. Therefore, protecting private data in terminal devices and applications has gradually become a focus of attention.

With the development of artificial intelligence technology, computer vision technology has a great application value in all the fields of security monitoring, finance, and even unmanned driving, etc.

### SUMMARY

Embodiments of the present disclosure provide a technical solution for face unlocking.

According to one aspect of the embodiments of the present disclosure, a face unlocking method is provided, including: performing face detection on one or more images; performing face feature extraction on an image in which a face is detected; performing authentication on extracted face features based on stored face features, wherein the stored face features at least include face features of face images of at least two different angles corresponding to a same identity (ID); and performing an unlocking operation at least in response to the extracted face features passing the authentication.

According to another aspect of the embodiments of the present disclosure, a face unlocking apparatus is provided, including: a face detection module, configured to perform face detection on one or more images; a feature extraction module, configured to perform face feature extraction on an image in which a face is detected; an authentication module, configured to authentication on extracted face features based on stored face features, wherein the stored face features at least include face features of face images of at least two different angles corresponding to a same identity (ID); and a control module, configured to perform an unlocking operation at least in response to the extracted face features passing the authentication.

According to yet another aspect of the embodiments of the present disclosure, an electronic device is provided, including: a processor and the face unlocking apparatus according to any one of the embodiments of the present disclosure, wherein when the processor runs the face unlocking apparatus to implement units in the face unlocking apparatus according to any one of the embodiments of the present disclosure.

According to yet another aspect of the embodiments of the present disclosure, an electronic device is provided, including: a memory, which stores executable instructions; and one or more processors, which communicate with the memory to execute the executable instructions to complete the method as described above.

According to yet another aspect of the embodiments of the present disclosure, a computer-readable medium is provided, configured to store computer-readable instructions that, when being executed, implement the method as described above.

The following further describes in detail the technical solutions of the present disclosure with reference to the accompanying drawings and embodiments.

### BRIEF DESCRIPTION OF THE DRAWINGS

The accompanying drawings constituting a part of the specification describe the embodiments of the present disclosure and are intended to explain the principles of the present disclosure together with the descriptions.

According to the following detailed descriptions, the present disclosure may be understood more clearly with reference to the accompanying drawings.

FIG. 1 is a flowchart of an embodiment of a face unlocking method according to the present disclosure.

FIG. 2 is a flowchart of another embodiment of a face unlocking method according to the present disclosure.

FIG. 3 is a flowchart of still another embodiment of a face unlocking method according to the present disclosure.

FIG. 4 is a flowchart of an embodiment of a face unlocking information registration method according to the present disclosure.

FIG. 5 is a flowchart of another embodiment of a face unlocking information registration method according to the present disclosure.

FIG. 6 is a flowchart of still another embodiment of a face unlocking information registration method according to the present disclosure.

FIG. 7 is a flowchart of yet another embodiment of a face unlocking information registration method according to the present disclosure.

FIG. 8 is a schematic structural diagram of an embodiment of a face unlocking apparatus according to the present disclosure.

FIG. 9 is a schematic structural diagram of another embodiment of a face unlocking apparatus according to the present disclosure.

FIG. 10 is a schematic structural diagram of an embodiment of an electronic device according to the present disclosure.

### DETAILED DESCRIPTION

Various exemplary embodiments of the present disclosure are now described in detail with reference to the accompanying drawings. It should be noted that, unless otherwise stated specifically, relative arrangement of the components and steps, the numerical expressions, and the values set forth in the embodiments are not intended to limit the scope of the present disclosure.

The following descriptions of at least one exemplary embodiment are merely illustrative actually, and are not intended to limit the present disclosure and the applications or uses thereof.

Technologies, methods and devices known to a person of ordinary skill in the related art may not be discussed in detail, but such technologies, methods and devices should be considered as a part of the specification in appropriate situations.

It should be noted that similar reference numerals and letters in the following accompanying drawings represent similar items. Therefore, once an item is defined in an accompanying drawing, the item does not need to be further discussed in the subsequent accompanying drawings.

The embodiments of the present disclosure may be applied to electronic devices such as terminal devices, computer systems, and servers, which may operate with numerous other general-purpose or special-purpose computing system environments or configurations. Examples of well-known terminal devices, computing systems, environments, and/or configurations suitable for use together with the electronic devices such as terminal devices, computer systems, and servers include, but are not limited to, personal computer systems, server computer systems, thin clients, thick clients, handheld or laptop devices, microprocessor-based systems, set top boxes, programmable consumer electronics, network personal computers, small computer systems, large computer systems, distributed cloud computing environments that include any one of the systems, and the like.

The electronic devices such as terminal devices, computer systems, and servers may be described in the general context of computer system executable instructions (such as, program modules) executed by the computer systems. Generally, the program modules may include routines, programs, target programs, components, logics, data structures, and the like for performing specific tasks or implementing specific abstract data types. The computer systems/servers may be practiced in the distributed cloud computing environments in which tasks are performed by remote processing devices that are linked through a communications network. In the distributed computing environments, the program modules may be located in local or remote computing system storage media including storage devices.

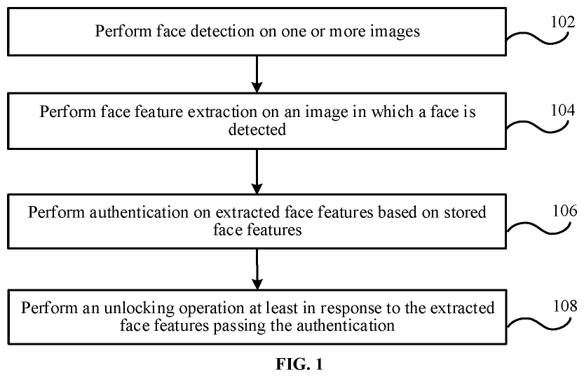

FIG. 1 is a flowchart of an embodiment of a face unlocking method according to the present disclosure. As shown in FIG. 1, the face unlocking method of this embodiment includes the following operations.

At 102: face detection is performed on one or more images.

In an optional example, the operation 102 may be executed by a processor by invoking a corresponding instruction stored in a memory, and may also be executed by a face detection module run by the processor.

At 104: face feature extraction is performed on an image in which a face is detected.

In an optional example, the operation 104 may be performed by the processor by invoking a corresponding instruction stored in the memory, and may also be performed by a feature extraction module run by the processor.

At 106: authentication is performed on extracted face features based on stored face features.

In the embodiments of the present disclosure, the stored face features at least include face features of face images of at least two different angles corresponding to a same identity (ID). The ID indicates user information corresponding to the stored face features, and for example, may be a user name, number, nickname, and the like.

In an optional example of the embodiments of the present disclosure, the face images of at least two different angles corresponding to the same ID include, but are not limited to, face images of the following two or more angles corresponding to the same ID: a frontal face image, a head-up face image, a head-down face image, a head-turned-left face image, a head-turned-right face image, and the like.

In an optional example, the operation 106 may be executed by the processor by invoking a corresponding instruction stored in the memory, or may be executed by an authentication module run by the processor.

At 108: an unlocking operation is performed at least in response to the extracted face features passing the authentication.

In an optional example, the operation 108 may be executed by the processor by invoking a corresponding instruction stored in the memory, and may also be executed by a control module run by the processor.

Based on the face unlocking method provided by the foregoing embodiments of the present disclosure, it is possible to pre-store face features of face images of at least two different angles corresponding to a same ID through a registration process, perform face detection on the images when performing face unlocking, perform face feature extraction on an image in which a face is detected, perform authentication on the extracted face features based on the stored face features, and perform an unlocking operation after the extracted face features pass the authentication, thereby implementing face-based authentication unlocking. The unlocking mode according to the embodiments of the present disclosure is simple in operation, high in convenience, and high in security. Moreover, according to the embodiments of the present disclosure, since the face features of the face images of at least two different angles corresponding to the same ID are pre-stored through the registration process, when a user corresponding to the same ID and the face image of any angle corresponding to the stored face features are obtained, face unlocking based on the user may be successfully implemented, thereby improving the success rate of face unlocking, and reducing the possibility of authentication failure due to the difference between the angle of the face at the time of authentication and the angle of the face at the time of registration of the same user.

In an optional example of the embodiments of the face unlocking method according to the present disclosure, the authentication performed on the extracted face features based on the stored face features in the operation 108 may be implemented as follows:

obtaining a similarity between the extracted face features and at least one stored face feature; and

in response to the similarity between the extracted face features and any stored face feature being greater than a set threshold, determining that the extracted face features pass the authentication.

Otherwise, if similarities between the extracted face features and the stored face features of all angles are not greater than the set threshold, it is determined that the extracted face features pass the authentication.

Based on this embodiment, the similarities between the extracted face features and the stored face features of all the angles may be compared one by one. As long as the similarity between the extracted face features and the stored face features of any angle is greater than the set threshold, it can be determined that the extracted face features pass the authentication. That is, in this embodiment, since it is possible to determine that the extracted face features pass the authentication by only comparing the similarity between the extracted face features and the stored face features of one angle or some angles, it is unnecessary to compare similarities between the extracted face features and the stored face features of the remaining angles, thereby facilitating improvement of authentication efficiency.

Alternatively, in another optional example of the embodiments of the face unlocking method according to the present disclosure, the authentication performed on the extracted face features based on the stored face features in the operation 108 may also be implemented as follows:

obtaining similarities between the extracted face features and multiple stored face features, respectively; and

in response to a maximum value among the similarities between the extracted face features and the multiple stored face features being greater than a set threshold, determining that the extracted face features pass the authentication.

The above-mentioned multiple stored face features may be stored face features of all the angles or face features of some of the angles. If the above-mentioned multiple stored face features are the stored face features of some angles, when the maximum value among the multiple similarities between the extracted face feature and the face features of the some angles is greater than the set threshold, it can be determined that the extracted face features pass the authentication, and it is unnecessary to further compare the similarities between the extracted face features and the face features of the remaining angles, thereby facilitating the improvement of the authentication efficiency. When the maximum value among the multiple similarities between the extracted face feature and the face features of the some angles is not greater than the set threshold, it is determined that the extracted face features do not pass the authentication, and it is possible to further select the face features of multiple angles from the stored face features of the remaining angles. In a similar manner, the maximum value among the multiple similarities between the further selected face features of the multiple angles and the extracted face features greater than the set threshold is obtained until the obtained maximum value among the multiple similarities is greater than the set threshold, it is determined that the extracted face features pass the authentication, or if the comparison of the similarities between the extracted face features and the stored face features of all the angles is completed, and there is no similarity of which the maximum value is greater than the set threshold, it is determined that the extracted face features do not pass the authentication.

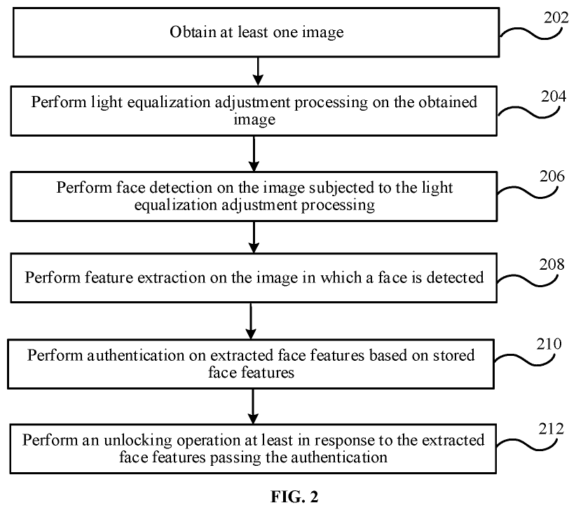

FIG. 2 is a flowchart of another embodiment of a face unlocking method according to the present disclosure. As shown in FIG. 2, the face unlocking method of this embodiment includes the following operations.

At 202: at least one image is obtained.

In an optional example, the operation 202 may be executed by a processor by invoking a camera, and may also be executed by a receiving module run by the processor.

At 204: light equalization adjustment processing is performed on the obtained image.

In an optional example of the embodiments of the present disclosure, the operation 204 may be directly executed to perform light equalization adjustment processing on the obtained image.

Alternatively, in another optional example of the embodiments of the present disclosure, before the operation 204, whether the quality of the obtained image satisfies a predetermined face detection condition may be determined first, and the operation 204 is then performed when the quality of the image does not satisfy the predetermined face detection condition to perform light equalization adjustment processing on the image. However, for the image with quality satisfying the predetermined face detection condition, the operation 204 is no longer performed, and face detection is directly performed on the image through operation 206. In this embodiment, a light equalization adjustment processing operation may no longer be performed on the image with quality satisfying the predetermined face detection condition, thereby facilitating the improvement of face unlocking efficiency.

The predetermined face detection condition, for example, may include, but not limited to, any one or more of the following: pixel value distribution of the image does not conform to a predetermined distribution range, an attribute value of the image is not within a predetermined value range, and the like. The attribute value of the image, for example, is attribute values such as chroma, brightness, contrast, and saturation of the image.

In an optional example, the operation 204 may be executed by the processor by invoking a corresponding instruction stored in a memory, and may also be executed by a light processing module run by the processor.

At 206: face detection is performed on the image subjected to the light equalization adjustment processing.

In the embodiments of the present disclosure, if no face is detected in the image, execution may selectively return to the operation 202, i.e., continuing the execution of the operation of obtaining the image. If no face is detected in the image, operation 208 is executed.

In an optional example, the operation 206 may be executed by the processor by invoking a corresponding instruction stored in the memory, and may also be executed by a face detection module run by the processor.

At 208: face feature extraction is performed on the image in which a face is detected.

In an optional example, the operation 208 may be executed by the processor by invoking a corresponding instruction stored in the memory, and may also be performed by a feature extraction module run by the processor.

At 210: authentication is performed on extracted face features based on stored face features.

In the embodiments of the present disclosure, the stored face features at least include face features of face images of at least two different angles corresponding to a same ID.

In an optional example, the operation 210 may be executed by the processor by invoking a corresponding instruction stored in the memory, or may be executed by an authentication module run by the processor.

At 212: an unlocking operation is performed at least in response to the extracted face features passing the authentication.

In an optional embodiment based on this embodiment, if the extracted face features pass the authentication, the ID corresponding to the extracted face features may also be obtained and displayed, so that a user knows the user information that currently passes the authentication.

If the extracted face features do not pass the authentication, the unlocking operation is not executed. Alternatively, in an optional embodiment of the face unlocking method according to the present disclosure, a face unlocking failure prompt message may also be output.

In an optional example, the operation 212 may be executed by the processor by invoking a corresponding instruction stored in the memory, and may also be executed by a control module run by the processor.

In actual situations, complex scenes such as backlight, hard light, and dark light are often encountered, for example, a situation in which lamp light comes from behind outdoors or indoor light is dim at night, or the like. In this case, if detection is performed on the face in the captured image, the background is too prominent and causes difficulty in face detection, or even if a face is detected, the face features extracted from the image are very blurred. Compared with the face detection of a general scene, the pixel values of the dark light scene are concentrated in a relatively low value area, the texture gradient is relatively small, the overall information features of the image are very blurred, and it is very difficult to detect valid information, especially faces. Moreover, with respect to the general scene, in the backlight and hard light scenes, although the overall brightness is similar, because the background light is very bright, both the contours and the detail textures of the face part are very blurred, resulting in that there is a very high difficulty in face feature extraction.

The present inventors discovered through research that: in images of complex illumination scenes such as backlight, hard light, and dim light, the pixel value distribution tends to have a certain locality and does not conform to the predetermined distribution range, and/or the attribute value of the image is not within the predetermined value range. For example, in the dim light scene, the pixel values are often concentrated in areas of relatively low values. In this case, the contrasts, chroma, etc. of the images are all very low, and it is difficult for a detector to process the faces in these images or misinformation may be generated.

In an optional example of the embodiment shown in FIG. 2, in operation 204, the performing light equalization adjustment processing on the obtained image may include: obtaining a grey-scale image of the image; and at least performing histogram equalization processing on the grey-scale image of the image, so that the pixel value distribution of the grey-scale image of the image may be evenly spread to the entire pixel value space, and meanwhile, the relative distribution of the original image pixel values is retained, in order to perform subsequent operations on the grey-scale image of the image subjected to the histogram equalization processing.

In another optional example of the embodiment shown in FIG. 2, in operation 204, the performing light equalization adjustment processing on the obtained image may include: at least performing image illumination conversion on the image in order to convert the image into an image that satisfies a predetermined illumination condition.

In an optional example of the embodiments of the present disclosure, the quality of the obtained image is detected, when the quality of the image does not satisfy the predetermined face detection condition, for example, when the brightness of the image does not satisfy a predetermined brightness condition, the histogram equalization processing is performed on the grey-scale image of the image, that is, firstly, histogram equalization is performed on the grey-scale image of the image, so that the pixel value distribution of the grey-scale image of the image may be uniformly spread to the entire pixel value space, and meanwhile, the relative distribution of the original image pixel values is retained, face detection is performed on the image subjected to the histogram equalization processing gain, the features in the grey-scale image of the image subjected to the histogram equalization processing are more obvious and the texture is clearer, thereby facilitating the face detection; alternatively, image illumination conversion is performed on the image to convert the image into an image that satisfies the predetermined illumination condition, and then face detection is performed, thereby facilitating the face detection. The embodiments of the present disclosure can still detect the face in the image more accurately under extreme illumination conditions such as dark light and backlight, especially for scenes where the indoor or night illumination is very dark and almost totally dark, or the background illumination is strong at night and the face is dim and the texture is blurred, the face can also be detected. Thus, the present disclosure may better implement the face unlocking application.

In addition, in still another embodiment of the face unlocking method according to the foregoing embodiments of the present disclosure, the method may further include: perform living body detection on the obtained image. Accordingly, in this embodiment, the unlocking operation is performed in response to the extracted face features passing the authentication and the imaging passing the living body detection.

Exemplarily, in the face unlocking method according to the embodiments of the present disclosure, it is possible to perform living body detection on the image after the image is obtained; or, it is also possible to perform, in response to a face being detected in the image, living body detection on the image in which the face is detected; or, it is further possible to perform, in response to the extracted face features pass the authentication, living body detection on the image with the extracted face features passing the authentication.

In an optional example of the embodiments of the present disclosure, performing living body on the image may include:

performing image feature extraction on the image by using neural network; detecting whether the extracted image features include at least one type of counterfeited clue information; and determining whether the image passes the living body detection based on a detection result of the at least one type of counterfeited clue information. If the extracted image features do not include any type of counterfeited clue information, the image passes the living body detection; otherwise, if the extracted image features include any one or more type of counterfeited clue information, the image does not pass the living body detection.

Exemplarily, the image features in the embodiments of the present disclosure, for example, may include, but not limited to, any one or more of the following: a Local Binary Pattern (LBP) feature, a Histogram of Sparse Code (HSC) feature, a panorama (LARGE) feature, a face map (SMALL) feature, and a face detail map (TINY) feature. In practical applications, feature items included in the image features needing to be extracted may be updated according to the counterfeited clue information that may occur.

Edge information in the image to be detected is highlighted by means of the LBP feature. The reflection and fuzzy information in the image is reflected more clearly by means of the HSC feature. The LARGE feature is a panorama feature, and the most obvious counterfeited clue (hack) in the image is extracted based on the LARGE feature. The face map (SMALL) is a region cut map having the size multiple (for example, 1.5 times the size) a face bounding box in the image to be detected and including a face and a portion where the face fits in with the background. The counterfeited clues such as reflection, a screen moiré pattern of a copying device, and the edge of a model or mask are extracted based on the SMALL feature. The face detail map (TINY) is a region cut map having the size of the face bounding box, and including a face. The counterfeited clues such as the image PS (photoshop editing), the screen moiré pattern of the copying device, and the texture of the model or mask are extracted based on the TINY feature. The counterfeited clues of the counterfeited faces included in the above-mentioned features may be learned by the neural network in advance by training the neural network, and then after the image including these counterfeited clues is input to the neural network, these counterfeited clues are all detected, thus it can be determined that the image is a counterfeited face image, or otherwise is a real face image, thereby implementing the living body detection of the face.

Exemplarily, the at least one type of counterfeited clue information in the embodiments of the present disclosure, for example, may include, but not limited to, any one or more of the following: 2D-type counterfeited clue information, 2.5D-type counterfeited clue information, and 3D-type counterfeited clue information. In some embodiments of the disclosure, the multiple dimensions of counterfeited clue information may be updated according to the counterfeited clue information that may appear.

The counterfeited clue information in the embodiments of the present disclosure may be observed by human eyes. The counterfeited clue information may be dimensionally divided into 2D-type, 2.5D-type, and 3D-type counterfeited clues. The 2D-type counterfeited face refers to a face image printed with a paper type material, and the 2D-type counterfeited clue information generally includes counterfeited information such as an edge of a paper face, the paper texture, paper reflection, and the paper edge. The 2.5D-type counterfeited face refers to a face image carried by a carrier device such as a video copying device, and the 2.5D-type counterfeited clue information generally includes counterfeited information such as a screen moiré pattern, screen reflection, and a screen edge of the carrier device such as the video copying device. The 3D-type counterfeited face refers to an actually existing counterfeited face, such as a mask, a model, a sculpture, and 3D printing, and the 3D-type counterfeited face also has corresponding counterfeited information such as seams of the mask, and a more abstract or too smooth skin of the model.

Based on the foregoing embodiments of the present disclosure, it is possible to detect whether an image is a counterfeited face image from multiple dimensions, and to detect different dimensions and various types of counterfeited face images, thereby improving the precision of counterfeited face detection and effective preventing criminals from using a photo or a video of a user to be verified for counterfeited attacks during the living body detection process. Furthermore, by performing face anti-counterfeiting detection through the neural network, it is possible to train and learn the counterfeited clue information of various counterfeited face modes. When a new counterfeited face mode occurs, the neural network may be trained and fine-tuned based on the new counterfeited clue information to quickly update the neural network, without improving the hardware structure, so as to quickly and effectively respond to new face anti-counterfeiting detection requirements.

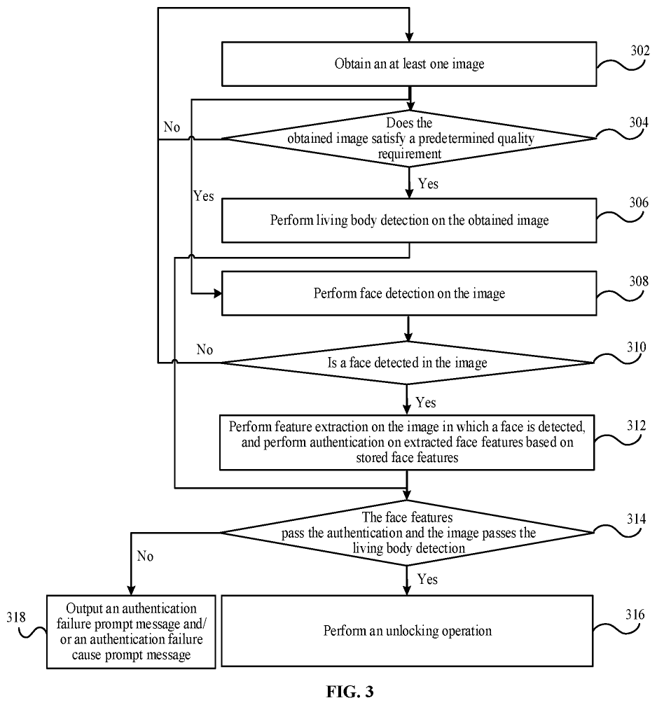

FIG. 3 is a flowchart of still another embodiment of a face unlocking method according to the present disclosure. In the embodiments of the present disclosure, the embodiments of the present disclosure are described by taking performing living body detection on the image after obtaining the image as an example. According to the description of the present disclosure, a person skilled in the art can know an implementation scheme for performing living body detection on the image in which a face is detected in response to the face being detected in the image. As shown in FIG. 3, the face unlocking method of this embodiment includes the following operations.

At 302: at least one image is obtained.

Then, operations 304 and 308 are executed respectively.

In an optional example, the operation 302 may be executed by a processor by invoking a camera, and may also be executed by a receiving module run by the processor.

At 304: whether the obtained image satisfies a predetermined quality requirement is identified.

A standard for the quality requirement may be preset to select a high-quality image for living body detection. The standard for the quality requirement, for example, may include one or more of the following: whether the face orientation is front-facing, the image definition, and the exposure level, and the like, and an image with relatively high comprehensive quality is selected for living body detection according to a corresponding standard.

Operation 306 is performed for the image in response to the image satisfying the predetermined quality requirement. Otherwise, in response to the image not satisfying the predetermined quality requirement, the operation 302 is executed again to obtain an image.

In an optional example, the operation 304 may be executed by the processor by invoking a corresponding instruction stored in a memory, and may also be executed by a light processing module run by the processor.

At 306: living body detection is performed on the obtained image.

Then, operation 314 is executed.

In an optional example, the operation 306 may be executed by the processor by invoking a corresponding instruction stored in the memory, or may be executed by a living body detection module run by the processor.

At 308: face detection is performed on the obtained images.

In some embodiments of the disclosure, the operation 308 may include: when the quality of the obtained image does not satisfy a predetermined face detection condition, first performing light equalization adjustment processing on the image, and then performing face detection on the image subjected to the light equalization adjustment processing. If the quality of the obtained image satisfies the predetermined face detection condition, face detection may be directly performed on the image.

In an optional example, the operation 308 may be executed by the processor by invoking a corresponding instruction stored in the memory, and may also be executed by a face detection module run by the processor.

At 310: whether a face is detected in the image is identified.

In response to a face being detected in the image, operation 312 is executed. Otherwise, in response to no face being detected in the image, the operation 302 may continue to be executed, i.e., re-obtaining the image and perform subsequent processes.

In an optional example, the operation 310 may be executed by the processor by invoking a corresponding instruction stored in the memory, and may also be executed by a face detection module run by the processor.

At 312: feature extraction is performed on the image in which a face is detected, and authentication is performed on extracted face features based on stored face features.

In the embodiments of the present disclosure, the stored face features at least include face features of face images of at least two different angles corresponding to a same ID.

In an optional example, the operation 312 may be executed by the processor by invoking a corresponding instruction stored in the memory, and may also be performed by a feature extraction module run by the processor.

At 314: whether the determined face features pass the authentication and whether the obtained image passes the living body detection are determined.

In response to the extracted face features passing the authentication and the obtained image passing the living body detection, operation 316 is executed. Otherwise, in response to the extracted face features not passing the authentication and/or the obtained image not passing the living body detection, the subsequent processes of this embodiment are not executed, or, operation 318 is optionally executed.

In an optional example, the operation 314 may be executed by the processor by invoking a corresponding instruction stored in the memory, or may be executed by an authentication module run by the processor.

At 316: an unlocking operation is performed.

In some embodiments of the disclosure, in another embodiment of the present disclosure, in response to the extracted face features passing the authentication, ID corresponding to the face features that pass the authentication may also be obtained from a pre-stored corresponding relationship and displayed.

In an optional example, the operation 316 may be executed by the processor by invoking a corresponding instruction stored in the memory, and may also be executed by a control module run by the processor.

Then, the subsequent processes of this embodiment are not executed.

At 318: an authentication failure prompt message and/or an authentication failure cause prompt message are output.

Authentication failure causes, for example, may be no face is detected, the face features do not pass the authentication and do not pass the living body detection (for example, the faces are detected to be photos, etc.), and the like.

In an optional example, the operation 318 may be executed by the processor by invoking a corresponding instruction stored in the memory, or may be executed by the authentication module or an interaction module run by the processor.

In addition, the face unlocking method according to still another embodiment of the present disclosure may further include:

in response to the extracted face features not passing the authentication, obtaining information about a predetermined number of allowed repetitions, accumulating the number of authentications in this process of the face unlocking method, and identifying whether the currently accumulated number of authentications reaches the number of allowed repetitions;

if the number of allowed repetitions is not reached, prompting the user to re-authenticate;

in response to the receipt of a re-authentication request sent by the user, returning to execute operation 102, 202 or 302, continuing to obtain the image, and re-executing the face unlocking process of this embodiment; and

in response to the current accumulated number of authentications reaching the number of allowed repetitions, executing an operation of outputting an authentication failure prompt message or an authentication failure cause prompt message.

The face unlocking method according to the embodiments of the present disclosure may be applied to all scenes where unlocking is needed, such as the unlocking of an electronic device screen, the unlocking of an application (APP), and face unlocking in an application. For example, when a mobile terminal is activated, the face unlocking method according to the embodiments of the present disclosure may be used to unlock the screen, the unlocking of the application may be performed through the face unlocking method according to the embodiments of the present disclosure in the APP of the mobile terminal, the face unlocking is performed through the face unlocking method according to the embodiments of the present disclosure in the payment application, and the like. Thus, the face unlocking method according to the embodiments of the present disclosure may trigger execution in response to the receipt of a face swiping authentication request sent by the user, or in response to the receipt of a face swiping authentication request sent by the application or the operating system, and the like. After unlocking, it is possible to normally operate the device, cope with the program, etc., or normally perform the subsequent process. For example, the electronic device that needs to be unlocked through a face may be used normally, and the electronic device (such as a mobile terminal) may be operated normally; an APP that needs to be unlocked through a face (for example, various shopping clients, bank clients, albums in terminals, etc.) may enter the APP after being unlocked, and the APP is used normally; and if face unlocking needs to be performed in the payment link of various APPs, the payment may be completed after the unlocking is successful, and the like.

Before the processes of the face unlocking method according to the foregoing embodiments of the present disclosure, the method may further include: obtaining the stored face features of face images of at least two different angles corresponding to the same ID through a face unlocking information registration process.

Exemplarily, the above-mentioned face unlocking information registration process may be implemented through the embodiment of the face unlocking information registration method in the following embodiments of the present disclosure.

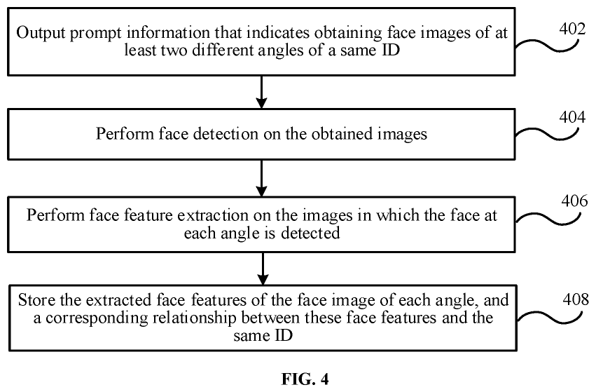

FIG. 4 is a flowchart of an embodiment of a face unlocking information registration method according to the present disclosure. As shown in FIG. 4, the face unlocking information registration method of this embodiment includes the following operations.

At 402: prompt information that indicates obtaining face images of at least two different angles of a same ID is output.

In an optional example, the operation 402 may be executed by a processor by invoking a corresponding instruction stored in a memory, and may also be executed by an interaction module run by the processor.

At 404: face detection is performed on the obtained images.

In an optional example, the operation 404 may be executed by the processor by invoking a corresponding instruction stored in the memory, and may also be executed by a face detection module run by the processor.

At 406: face feature extraction is performed on the images in which the face at each angle is detected.

In an optional example, the operation 406 may be executed by the processor by invoking a corresponding instruction stored in the memory, and may also be performed by a feature extraction module run by the processor.

At 408: the extracted face features of the face image of each angle, and a corresponding relationship between the face features of the face image of each angle and the same ID are stored.

In the embodiments of the present disclosure, the stored face features at least include face features of face images of at least two different angles corresponding to a same ID. The ID indicates user information corresponding to the stored face features, and for example, may be a user name, number, and the like.

In an optional example of the embodiments of the present disclosure, the face images of at least two different angles corresponding to the same ID include, but are not limited to, face images of the following two or more angles corresponding to the same ID: a frontal face image, a head-up face image, a head-down face image, a head-turned-left face image, a head-turned-right face image, and the like.

In an optional example, the operation 408 may be executed by the processor by invoking a corresponding instruction stored in the memory, and may also be executed by a storage module run by the processor.

Based on the face unlocking information registration method by the foregoing embodiments of the present disclosure, it is possible to pre-store face features of face images of at least two different angles corresponding to a same ID through a registration process, in order to perform face unlocking subsequently based on the face features of the at least two different angle face images corresponding to the same ID, thereby facilitating improvement of the success rate of the face unlocking, and reduce the possibility of authentication failure due to the difference between the angle of the face at the time of authentication and the angle of the face at the time of registration of the same user.

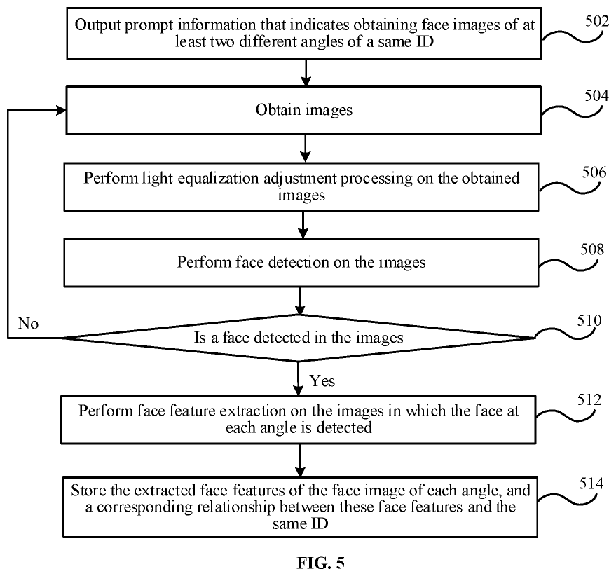

FIG. 5 is a flowchart of another embodiment of a face unlocking information registration method according to the present disclosure. As shown in FIG. 5, the face unlocking information registration method of this embodiment includes the following operations.

At 502: prompt information that indicates obtaining face images of at least two different angles of a same ID is output.

In an optional example, the operation 502 may be executed by a processor by invoking a corresponding instruction stored in a memory, and may also be executed by an interaction module run by the processor.

At 504: an image is obtained.

In an optional example, the operation 504 may be executed by the processor by invoking a camera, and may also be executed by a face detection module run by the processor.

At 506: light equalization adjustment processing is performed on the obtained image.

In an optional example of the embodiments of the present disclosure, the operation 506 may be directly executed to perform light equalization adjustment processing on the obtained image.

Alternatively, in another optional example of the embodiments of the present disclosure, before the operation 506, whether the quality of the obtained image satisfies a predetermined face detection condition may be determined first, and the operation 506 is then performed when the quality of the image does not satisfy the predetermined face detection condition to perform light equalization adjustment processing on the obtained image. For the image with quality satisfying the predetermined face detection condition, the operation 506 is no longer performed, and face detection is directly performed on the image through operation 508. In this embodiment, a light equalization adjustment processing operation may no longer be performed on the image with quality satisfying the predetermined face detection condition, thereby facilitating the improvement of face unlocking efficiency.

The predetermined face detection condition, for example, may include, but not limited to, any one or more of the following: pixel value distribution of the image does not conform to a predetermined distribution range, an attribute value of the image is not within a predetermined value range, and the like. The attribute value of the image, for example, is attribute values such as chroma, brightness, contrast, and saturation of the image, and the like.

In an optional example of this embodiment, in operation 506, the performing light equalization adjustment processing on the obtained image may include: obtaining a grey-scale image of the image; and at least performing histogram equalization processing on the grey-scale image of the image, so that the pixel value distribution of the grey-scale image of the image may be evenly spread to the entire pixel value space, and the relative distribution of the original image pixel values is also retained, so as to perform subsequent operations on the grey-scale image of the image subjected to the histogram equalization processing.

In another optional example of this embodiment, in operation 506, the performing light equalization adjustment processing on the obtained image may include: at least performing image illumination conversion on the image in order to convert the image into an image that satisfies a predetermined illumination condition.

In an optional example, the operation 506 may be executed by the processor by invoking a corresponding instruction stored in a memory, and may also be executed by a light processing module run by the processor.

At 508: face detection is performed on the obtained images.

In an optional example, the operation 508 may be executed by the processor by invoking a corresponding instruction stored in the memory, and may also be executed by a face detection module run by the processor.

At 510: whether a face is detected in the image is identified.

In response to a face being detected in the image, operation 512 is executed. Otherwise, in response to no face being detected in the image, execution returns to operation 504 to re-obtain an image.

In an optional example, the operation 510 may be executed by the processor by invoking a corresponding instruction stored in the memory, and may also be executed by a face detection module run by the processor.

At 512: face feature extraction is performed on the images in which the face at each angle is detected.

In an optional example, the operation 512 may be executed by the processor by invoking a corresponding instruction stored in the memory, and may also be performed by a feature extraction module run by the processor.

At 514: the extracted face features of the face image of each angle, and a corresponding relationship between these face features and the same ID are stored.

In an optional example, the operation 514 may be executed by the processor by invoking a corresponding instruction stored in the memory, and may also be executed by a face detection module run by the processor.

In the embodiments of the present disclosure, the obtained image is subjected first to light equalization adjustment processing, and then to face detection, thereby facilitating face detection. Under extreme illumination conditions such as dark light and backlight, it is still possible to detect the face in the image more accurately, especially for scenes where the indoor or night illumination is very dark and almost totally dark, or the background illumination is strong at night and the face is dim and the texture is blurred, the face may also be detected. Thus, the present disclosure may better implement the face unlocking application.

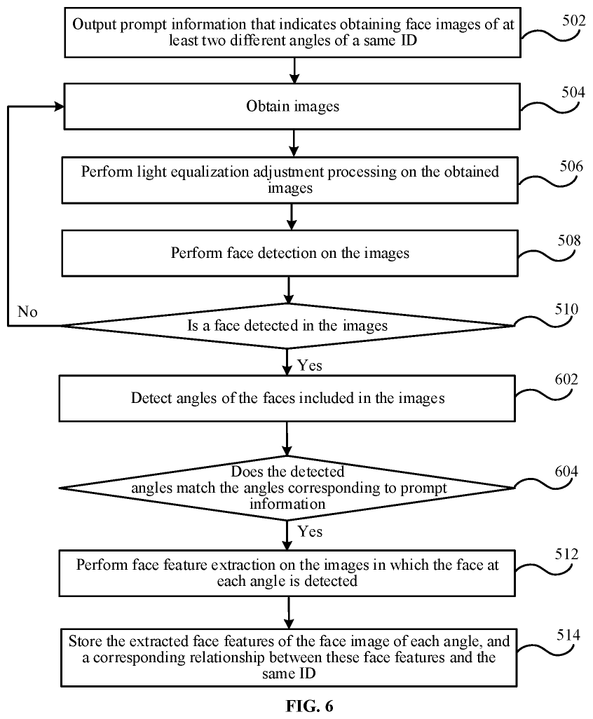

FIG. 6 is a flowchart of still another embodiment of a face unlocking information registration method according to the present disclosure. As shown in FIG. 6, compared with the embodiment shown in FIG. 5, in the face unlocking information registration method of this embodiment, before the operation 514, for example, before, after or at the same time of the operation 512, the following operations are executed.

At 602: an angle of the face included in the image is detected.

In an optional example, the operation 602 may be executed by a processor by invoking a corresponding instruction stored in a memory, and may also be executed by a storage module run by the processor.

At 604: whether the detected angle matches the angle corresponding to prompt information is determined. When it is determined that the detected angle matches an angle corresponding to the prompt information, operation 512 of performing face feature extraction on the face at each angle, or operation 514 of storing the extracted face features of the face image of each angle, and the corresponding relationship between the face features of the face image of each angle and the same ID is executed.

In another embodiment, in response to the detected angle not matching the angle corresponding to the prompt information, new prompt information that indicates re-inputting the face image of this angle may also be output, so as to adjust the angle of the face to re-execute the process of the face unlocking information registration method according to the embodiments of the present disclosure.

In an optional example, the operation 604 may be executed by a processor by invoking a corresponding instruction stored in a memory, and may also be executed by a storage module run by the processor.

In an optional example of the embodiment shown in FIG. 6, the operation 602 of detecting the angle of the face included in the image may include:

performing key point detection on the face;

calculating the angle of the face according to the detected key points, such as the left and right angles and the up and down angles of the face; and

determining whether the detected angle matches an angle corresponding to the prompt information according to the calculated angle of the face.

In the embodiments of the present disclosure, face unlocking may be performed on the user based on the face features stored in the face unlocking information registration process subsequently. In order to avoid a face unlocking failure due to that the angle of the face participating in the face unlocking is different from that in the registration when performing the face unlocking subsequently, and improve the success rate of the face unlocking, the face features of face images of multiple angles (such as, five angles) may be stored for the same user in the embodiments of the present disclosure. The faces at different angles may be, for example, faces at five angles of front, head up, head down, head turn left, and head turn right. In the embodiments of the present disclosure, the angles of the face may be expressed by the left and right angles and the up and down angles of the face (i.e., the head). When a frontal face may be set, the left and right angles and the up and down angles of the face are zero.

Accordingly, in another optional example of the embodiment shown in FIG. 6, in operation 502, the outputting the prompt information that indicates obtaining face images of at least two different angles of the same ID may include: selecting a predetermined angle and prompting the user to enter the face image of the predetermined angle according to predetermined multi-angle parameters. The multi-angle parameters include information about the multiple angles of face images needing to be obtained. Accordingly, in this example, after storing the extracted face features of the face image of each angle, and the corresponding relationship between these face features and the same ID may further include: identifying whether all predetermined angles corresponding to the multi-angle parameters are completely selected; and in response to not completely selecting all the predetermined angles corresponding to the multi-angle parameters, selecting the next predetermined angle and perform the embodiment shown in FIG. 5 or FIG. 6 for the next predetermined angle. If all the predetermined angles corresponding to the multi-angle parameters are completely selected, the face unlocking information registration is completed.

In some embodiments of the disclosure, in response to completing the selection of all the predetermined angles corresponding to the multi-angle parameters or after extracting the face features of one angle each time, the prompt information for prompting the user to input the same ID may also be output. Accordingly, the storing the extracted face features of the face image of each angle, and the corresponding relationship between these face features and the same ID includes: storing the extracted face features of the face images of at least two angles and the ID input by the user, and establishing the corresponding relationship between the ID and the face features of the face images of at least two angles.

Based on the above-mentioned examples, the storing the face features of faces at multiple different angles for the same user is implemented.

The face unlocking information registration method according to the foregoing embodiments of the present disclosure may further include: performing living body detection on the image. Accordingly, in the foregoing embodiments of the face unlocking method of the present disclosure, in response to the image passing the living body detection, the operation of storing the extracted face features of the face image of each angle, and the corresponding relationship between the face features of the face image of each angle and the same ID is executed.

Exemplarily, in the face unlocking method according to the embodiments of the present disclosure, for performing living body detection on the image, it is possible to perform, after the image is obtained, living body detection on the obtained image; or, it is also possible to face feature extraction on the images in which the face at each angle is detected; alternatively, perform living body detection on the image in response to the detected angle of the face matching the predetermined angle; or, it is further possible to perform living body detection on the imager after performing feature extraction on the face.

For the implementation of performing living body detection in the image in the embodiments of the face unlocking information registration method of the present disclosure, reference may be made to the implementation performing living body detection on the image in the embodiments of the face unlocking method of the present disclosure.

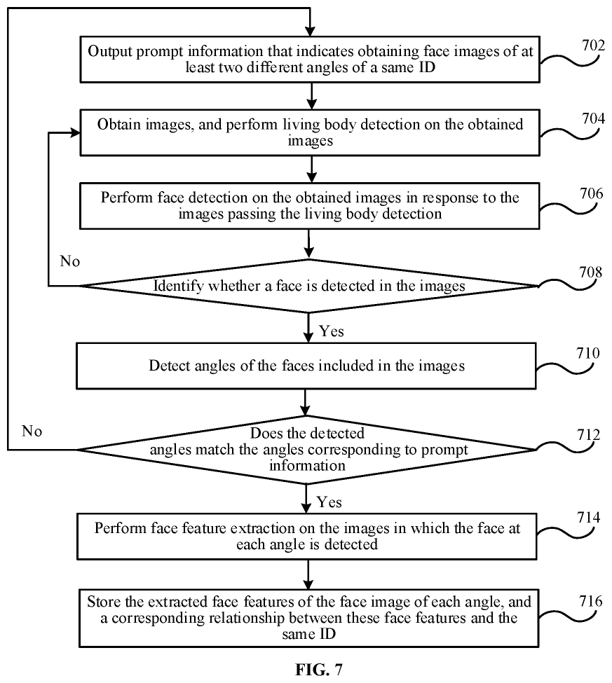

FIG. 7 is a flowchart of yet another embodiment of a face unlocking information registration method according to the present disclosure. In the embodiments of the present disclosure, the embodiments of the present disclosure are described by taking performing living body detection on the image after obtaining the image as an example. According to the description of the present disclosure, a person skilled in the art can know implementation schemes for performing living body detection on the images in which the face at each angle is detected, performing living body detection on the image in response to the detected angle of the face matching the predetermined angle, and performing living body detection on the image after performing face extraction on the images in which the face at each angle is detected. Details are not described here again. As shown in FIG. 7, the face unlocking information registration method of this embodiment includes the following operations.

At 702: prompt information that indicates obtaining face images of at least two different angles of a same ID is output.

In an optional example, the operation 702 may be executed by a processor by invoking a corresponding instruction stored in a memory, and may also be executed by an interaction module run by the processor.

At 704: an image is obtained, and living body detection is performed on the obtained image.

In response to the imaging passing the living body detection, operation 706 is executed. Otherwise, if the image does not pass the living body detection, subsequent processes of this embodiment are not performed.

In an optional example, the operation 704 may be executed by the processor by invoking a camera and a corresponding instruction stored in the memory, or may be executed by a living body detection module run by the processor.

At 706: face detection is performed on the obtained images.

In an optional example, the operation 706 may be executed by the processor by invoking a corresponding instruction stored in the memory, and may also be executed by a face detection module run by the processor.

At 708: whether a face is detected in the image is identified.

In response to a face being detected in the image, operation 710 is executed. If no face is detected in the image, the operation 702 continues to be executed, or the obtaining of the image continues and the operation 704 is executed.

In an optional example, the operation 708 may be executed by the processor by invoking a corresponding instruction stored in the memory, and may also be executed by a face detection module run by the processor.

At 710: an angle of the face included in the image is detected.

In an optional example, the operation 710 may be executed by a processor by invoking a corresponding instruction stored in a memory, and may also be executed by a storage module run by the processor.

At 712: whether the detected angle matches the angle corresponding to prompt information is determined.

In response to the detected angle matching the angle corresponding to prompt information, operation 714 is executed. Otherwise, if the detected angle does not match the angle corresponding to the prompt information, the operation 702 is re-executed.

In an optional example, the operation 712 may be executed by a processor by invoking a corresponding instruction stored in a memory, and may also be executed by a storage module run by the processor.

At 714: face feature extraction is performed on the images in which the face at each angle is detected.

In an optional example, the operation 714 may be executed by the processor by invoking a corresponding instruction stored in the memory, and may also be performed by a feature detection module run by the processor.

At 716: the extracted face features of the face image of each angle, and a corresponding relationship between the face features of the face image of each angle and the same ID are stored.

In addition, as still another embodiment of the face unlocking information registration method of the present disclosure, in the operation 704 of the embodiment shown in FIG. 7, it is possible to identify whether the obtained image satisfies a predetermined quality requirement; perform living body detection on the image in response to the image satisfying the predetermined quality requirement; otherwise, continuing to execute operation 702 or 704 in response to the image not satisfying the predetermined quality requirement.

In an optional example, the operation 716 may be executed by a processor by invoking a corresponding instruction stored in a memory, and may also be executed by a storage module run by the processor.

Based on the foregoing embodiments of the present disclosure, it is possible to detect whether an image is a counterfeited face image from multiple dimensions, and to detect different dimensions and various types of counterfeited face images, thereby improving the precision of counterfeited face detection, effective preventing criminals from using a photo or a video of a user to be verified for counterfeited attacks during the living body detection process, and ensuring that the image during the face unlocking information registration is a real user image. Furthermore, by performing face anti-counterfeiting detection through the neural network, it is possible to train and learn the counterfeited clue information of various counterfeited face modes. When a new counterfeited face mode occurs, the neural network may be trained and fine-tuned based on the new counterfeited clue information to quickly update the neural network, without improving the hardware structure, so as to quickly and effectively respond to new face anti-counterfeiting detection requirements.

The face unlocking information registration method according to the embodiments of the present disclosure may start to be executed in response to the receipt of a face entering request sent by a user, or start to be executed in response to the receipt of a face entering request sent by an application or an operating system.

Any face unlocking method and face unlocking information registration method provided by the embodiments of the present disclosure may be executed by any appropriate device having data processing capability, including, but not limited to, a terminal device, a server, and the like. Alternatively, any face unlocking method and face unlocking information registration method provided by the embodiments of the present disclosure may be executed by a processor, for example, the processor executes any face unlocking method and face unlocking information registration method mentioned in the embodiments of the present disclosure by invoking corresponding instructions stored in a memory. Details are not described below again.

A person of ordinary skill in the art may understand that all or some steps for implementing the foregoing method embodiments are achieved by a program by instructing related hardware; the foregoing program can be stored in a computer-readable storage medium; when the program is executed, steps including the foregoing method embodiments are executed. Moreover, the foregoing storage medium includes various media capable of storing program codes, such as a Read-Only Memory (ROM), a Random-Access Memory (RAM), a magnetic disk, or an optical disk.

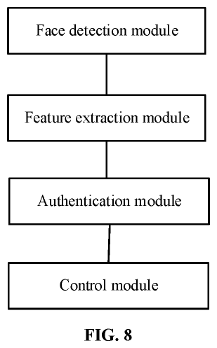

FIG. 8 is a schematic structural diagram of an embodiment of a face unlocking apparatus according to the present disclosure. The face unlocking apparatus of this embodiment may be configured to implement the foregoing method embodiments of the present disclosure. As shown in FIG. 8, the face unlocking apparatus of this embodiment includes: a face detection module, a feature extraction module, an authentication module, and a control module, wherein

the face detection module is configured to perform face detection on one or more images;

the feature extraction module is configured to perform face feature extraction on an image in which a face is detected; and

the authentication module is configured to perform authentication on extracted face features based on stored face features.

The stored face features at least include face features of face images of at least two different angles corresponding to a same ID. Exemplarily, the face images of at least two different angles corresponding to the same ID, for example, include, but are not limited to, face images of the following two or more angles corresponding to the same ID: a frontal face image, a head-up face image, a head-down face image, a head-turned-left face image, a head-turned-right face image, and the like.

The control module is configured to perform an unlocking operation at least in response to the extracted face features passing the authentication.

In one optional example, the authentication module is configured to obtain a similarity between the extracted face features and at least one stored face feature; and in response to any obtained similarity being greater than a set threshold, determine that the extracted face features pass the authentication. In another optional example, the authentication module is configured to obtain similarities between the extracted face features and multiple stored face features, respectively; and in response to a maximum value in multiple obtained similarities being greater than the set threshold, determine that the extracted face features pass the authentication.

The face unlocking apparatus provided by the embodiments of the present disclosure performs face detection on images, performs face feature extraction on an image in which a face is detected, performs authentication on the extracted face features based on the stored face features, and performs an unlocking operation after the extracted face features pass the authentication, thereby implementing face-based authentication unlocking. The unlocking mode according to the embodiments of the present disclosure is simple in operation, high in convenience, and high in security. Moreover, according to the embodiments of the present disclosure, since the face features of the face images of at least two different angles corresponding to the same ID are pre-stored through the registration process, when a user corresponding to the same ID and the face image of any angle corresponding to the stored face features are obtained, face unlocking based on the user may be successfully implemented, thereby improving the success rate of face unlocking, and reducing the possibility of authentication failure due to the difference between the angle of the face at the time of authentication and the angle of the face at the time of registration of the same user.

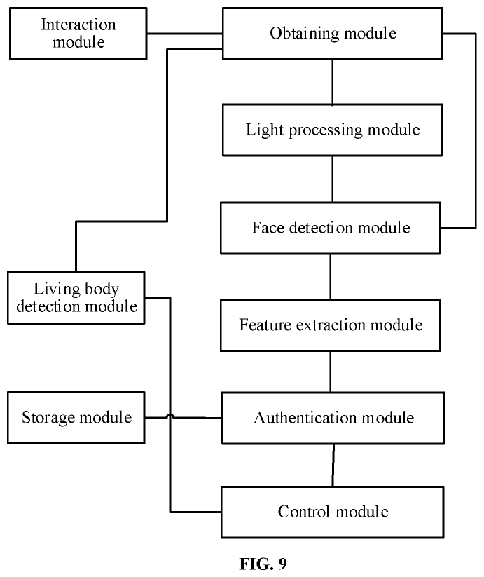

FIG. 9 is a schematic structural diagram of another embodiment of a face unlocking apparatus according to the present disclosure. As shown in FIG. 9, compared with the embodiment shown in FIG. 8, the face unlocking apparatus of this embodiment further includes: an obtaining module and a light processing module, wherein

the obtaining module is configured to obtain an image. The obtaining module, for example, may be a camera or other image acquisition devices.

The light processing module is configured to perform light equalization adjustment processing on an image.

Accordingly, the face detection module is configured to perform face detection on the image subjected to the light equalization adjustment processing.

In one optional example, the light processing module is configured to obtain a grey-scale image of the image, and at least perform histogram equalization processing on the grey-scale image of the image. In another optional example, the light processing module is configured to at least perform image illumination conversion on the image in order to convert the image into an image that satisfies a predetermined illumination condition. In another optional example, the light processing module is configured to determine that the quality of the image does not satisfy a predetermined face detection condition, and perform light equalization adjustment processing on the image. The predetermined face detection condition, for example, may include, but not limited to, any one or more of the following: pixel value distribution of the image does not conform to a predetermined distribution range, and an attribute value of the image is not within a predetermined value range.

Further, referring to FIG. 9 again, in still another embodiment of the face unlocking apparatus according to the present disclosure, the apparatus may further include: an interaction module and a storage module. The interaction module is configured to output prompt information that indicates obtaining face images of at least two different angles of a same ID. The storage module is configured to store extracted face features of the face image of each angle extracted by the feature extraction module, and a corresponding relationship between these face features and the same ID.

In one optional example, the storage module is configured to detect an angle of the face included in the image; and determine that the detected angle matches an angle corresponding to the prompt information, and store the extracted face features of the face image of each angle extracted by the feature extraction module, and the corresponding relationship between these face features and the same ID.

In another optional example, the storage module is configured, when detecting the angle of the face included in the image, to perform face key point detection on the image; and calculate the angle of the face included in the image according to detected face key points.

In addition, in still another embodiment of the face unlocking apparatus according to the present disclosure, the storage module is further configured to request, when the detected angle does not match the angle corresponding to the prompt information, the interaction module to output new prompt information that indicates re-inputting the face image of this angle.

In yet another optional example, the storage module is configured to identify whether storing the face features of the face images of at least two different angles of the same ID is completed; in response to the storing the face images of at least two different angles of the same ID being not completed, request the interaction module to execute the operation of outputting the prompt information that indicates obtaining face images of at least two different angles of the same ID; in response to the storing the face images of at least two different angles of the same ID being completed, request the interaction module to output prompt information for prompting a user input the same ID; and store the extracted face features of the face images of at least two angles and the same ID input by the user, and establish a corresponding relationship between the same ID and the face features of the face images of at least two angles.

Further, referring to FIG. 9 again, in still another embodiment of the face unlocking apparatus according to the present disclosure, the apparatus may further include: a living body detection module, configured to perform living body detection on the image. Accordingly, in this embodiment, the control module is configured to perform the unlocking operation at least in response to the extracted face features passing the authentication and the imaging passing the living body detection.

In one optional example, the living body detection module is configured to perform living body detection on the image in response to the image satisfying a predetermined quality requirement.

In another optional example, the living body detection module may be implemented through a neural network. The neural network is configured to: perform image feature extraction on the image; detect whether the extracted image features include at least one type of counterfeited clue information; and determine whether the image passes the living body detection based on a detection result of the at least one type of counterfeited clue information.

The image features extracted from the image by using the neural network, for example, include, but are not limited to, one or more of the following: an LBP feature, a HSC feature, a LARGE feature, a SMALL feature, and a TINY feature.

The at least one type of counterfeited clue information, for example, includes, but is not limited to, any one or more of the following: 2D-type counterfeited face information, 2.5D-type counterfeited face information, and 3D-type counterfeited face information.

The 2D-type counterfeited face information includes information that the face images are printed with a paper type material; and/or the 2.5D-type counterfeited face information includes information that the face images are carried by a carrier device; and/or the 3D-type counterfeited face information include information about counterfeited faces.

The embodiments of the present disclosure further provide an electronic device, including: the face unlocking apparatus according to any one of the foregoing embodiments of the present disclosure.

In addition, the embodiments of this disclosure further provide another electronic device, including:

a processor and the face unlocking apparatus according to any one of the embodiments of the present disclosure, wherein

the processor runs the face unlocking apparatus to implement modules in the face unlocking apparatus according to any one of the foregoing embodiments.

In addition, the embodiments of the present disclosure further provide still another electronic device, including:

a memory, which stores executable instructions; and

one or more processors, which communicate with the memory to execute the executable instructions so as to complete operations in steps of the face unlocking method or the face unlocking information registration method according to any one of the foregoing embodiments of the present disclosure.

In addition, the embodiments of the present disclosure further provide a computer program, including a computer-readable code, where when the computer-readable code is run on a device, a processor in the device executes instructions for implementing steps of the face unlocking method or the face unlocking information registration method according to any one of the foregoing embodiments of the present disclosure.

In addition, the embodiments of the present disclosure further provide a computer-readable medium having stored thereon computer-readable instructions. When the instructions are executed, operations in steps of the face unlocking method or the face unlocking information registration method according to any one of the foregoing embodiments of the present disclosure are implemented.

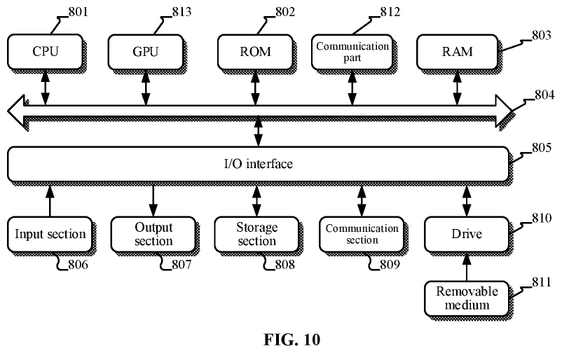

FIG. 10 is a schematic structural diagram of an embodiment of an electronic device according to the present disclosure. Referring to FIG. 10 below, a schematic structural diagram of an electronic device suitable for implementing a terminal device or a server according to the embodiments of the present application is shown. As shown in FIG. 10, the electronic device includes one or more processors, a communication part, and the like. The one or more processors are, for example, one or more CPUs 801, and/or one or more Graphic Processing Units (GPUs) 813, and the like. The processor may execute various appropriate actions and processing according to executable instructions stored in a Read-Only Memory (ROM) 802 or executable instructions loaded from a storage section 808 to a RAM 803. The communication part 812 may include, but is not limited to, a network card. The network card may include, but is not limited to, an Infiniband (IB) network card. The processor may communicate with the ROM 802 and/or the RAM 803, to execute executable instructions. The processor is connected to the communication part 812 via a bus 804, and communicates with other target devices via the communication part 812, thereby implementing corresponding operations of any method provided in the embodiments of the present application, for example, performing face detection on an image; performing face feature extraction on the image in which a face is detected; performing authentication on extracted face features based on stored face features, wherein the stored face features at least include face features of face images of at least two different angles corresponding to a same identity (ID); and performing an unlocking operation at least in response to the extracted face features passing the authentication. Alternatively, prompt information that indicates obtaining the face images of at least two different angles of the same ID is output; face feature extraction is performed on the images in which the face at each angle is detected; and the extracted face features of the face image of each angle, and a corresponding relationship between the face features of the face image of each angle and the same ID are stored.

In addition, the RAM 803 may further store various programs and data required for operations of an apparatus. The CPU 801, the ROM 802, and the RAM 803 are connected to each other by means of the bus 804. In the presence of the RAM 803, the ROM 802 is an optional module. The RAM 803 stores executable instructions, or writes the executable instructions into the ROM 802 during running, where the executable instructions cause the CPU 801 to execute corresponding operations of the foregoing method. An Input/Output (I/O) interface 805 is also connected to the bus 804. The communication part 812 is integrated, or is configured to have multiple sub-modules (for example, multiple IB network cards) connected to the bus.

The following components are connected to the I/O interface 805: an input section 806 including a keyboard, a mouse and the like; an output section 807 including a Cathode-Ray Tube (CRT), a Liquid Crystal Display (LCD), a speaker and the like; the storage section 808 including a hard disk drive and the like; and a communication section 809 of a network interface card including an LAN card, a modem and the like. The communication section 809 performs communication processing via a network such as the Internet. A drive 810 is also connected to the I/O interface 805 according to requirements. A removable medium 811 such as a magnetic disk, an optical disk, a magneto-optical disk, a semiconductor memory or the like is mounted on the drive 811 according to requirements, so that a computer program read from the removable medium is installed on the storage section 808 according to requirements.

It should be noted that the architecture illustrated in FIG. 10 is merely an optional implementation mode. During specific practice, the number and types of the components in FIG. 10 may be selected, decreased, increased, or replaced according to actual requirements. Different functional components may be separated or integrated or the like. For example, the GPU 813 and the CPU 801 may be separated, or the GPU 813 may be integrated on the CPU 801, and the communication part may be separated from or integrated on the CPU 801 or the GPU 813 or the like. These alternative implementations all fall within the scope of protection of the present disclosure.

Particularly, a process described above with reference to a flowchart according to the embodiments of the present disclosure may be implemented as a computer software program. For example, the embodiments of the present disclosure include a computer program product, which includes a computer program tangibly contained on a machine-readable medium. The computer program includes a program code configured to execute the method shown in the flowchart. The program code may include corresponding instructions for correspondingly executing the steps of the method provided by the embodiments of the present application, for example, performing face detection on an image; performing face feature extraction on the image in which a face is detected; performing authentication on extracted face features based on stored face features, wherein the stored face features at least include face features of face images of at least two different angles corresponding to a same identity (ID); and performing an unlocking operation at least in response to the extracted face features passing the authentication. Alternatively, prompt information that indicates obtaining the face images of at least two different angles of the same ID is output; face detection is performed on the obtained images; face feature extraction is performed on the images in which the face at each angle is detected; and the extracted face features of the face image of each angle, and a corresponding relationship between these face features and the same ID are stored.

The embodiments in the specification are all described in a progressive manner, for same or similar parts in the embodiments, refer to these embodiments, and each embodiment focuses on a difference from other embodiments. The system embodiments correspond to the method embodiments substantially and therefore are only described briefly, and for the associated part, refer to the descriptions of the method embodiments.

The methods, apparatuses, and devices in the present disclosure are implemented in many manners. For example, the methods, apparatuses, and devices of the present disclosure may be implemented with software, hardware, firmware, or any combination of software, hardware, and firmware. The foregoing sequence of the steps of the method is merely for description, and unless otherwise stated particularly, the steps of the method in the present disclosure are not limited to the optionally described sequence. In addition, in some embodiments, the present disclosure may also be implemented as programs recorded in a recording medium. The programs include machine-readable instructions for implementing the methods according to the present disclosure. Therefore, the present disclosure further covers the recording medium storing the programs for executing the methods according to the present disclosure.

The descriptions of the present disclosure are provided for the purpose of examples and description, and are not intended to be exhaustive or limit the present disclosure to the disclosed form. Many modifications and changes are obvious to a person of ordinary skill in the art. The embodiments are selected and described to better describe a principle and an actual application of the present disclosure, and to make persons of ordinary skill in the art understand the present disclosure, so as to design various embodiments with various modifications applicable to particular use.

1. A face unlocking method, comprising:
performing face detection on one or more images;
performing face feature extraction on an image in which a face is detected;
performing authentication on extracted face features based on stored face features, wherein the stored face features at least comprise face features of face images of at least two different angles corresponding to a same identity (ID); and
performing an unlocking operation at least in response to the extracted face features passing the authentication.

2. The method according to claim 1, wherein the face images of at least two different angles corresponding to the same ID comprise face images of the following two or more angles corresponding to the same ID: a frontal face image, a head-up face image, a head-down face image, a head-turned-left face image, or a head-turned-right face image.

3. The method according to claim 1, wherein before performing face detection on the one or more images, the method further comprises: performing light equalization adjustment processing on each image; and
the performing face detection on the one or more images comprises: performing face detection on the image subjected to the light equalization adjustment processing.

4. The method according to claim 3, wherein the performing light equalization adjustment processing on each image comprises:
obtaining a grey-scale image of the image; and
performing histogram equalization processing on the grey-scale image of the image.

5. The method according to claim 3, wherein the performing light equalization adjustment processing on each image comprises:
performing image illumination conversion on the image to convert the image into an image that satisfies a predetermined illumination condition.

6. The method according to claim 3, wherein before performing light equalization adjustment processing on each image, the method further comprises:
determining that a quality of the image does not satisfy a predetermined face detection condition,
wherein the predetermined face detection condition comprises any one or more of the following: pixel value distribution of the image does not conform to a predetermined distribution range, or an attribute value of the image is not within a predetermined value range.

7. The method according to claim 1, wherein the performing authentication on extracted face features based on stored face features comprises:
obtaining a similarity between the extracted face features and at least one stored face feature, and in response to the similarity between the extracted face features and any stored face feature being greater than a set threshold, determining that the extracted face features pass the authentication; or
obtaining similarities between the extracted face features and multiple stored face features, respectively, and in response to a maximum value among values of the similarities between the extracted face features and the multiple stored face features being greater than a set threshold, determining that the extracted face features pass the authentication.

8. The method according to claim 1, further comprising: performing living body detection on the image, wherein
the performing an unlocking operation at least in response to the extracted face features passing the authentication comprises: performing the unlocking operation in response to the extracted face features passing the authentication and the image passing the living body detection.

9. The method according to claim 8, wherein the performing living body detection on the image comprises:
performing image feature extraction on the image by using a neural network;
detecting whether the extracted image features comprise at least one type of counterfeited clue information; and
determining whether the image passes the living body detection based on a detection result of the at least one type of counterfeited clue information.

10. The method according to claim 9, wherein the image features extracted from the image by using the neural network comprise one or more of the following: a Local Binary Pattern (LBP) feature, a Histogram of Sparse Code (HSC) feature, a panorama (LARGE) feature, a face map (SMALL) feature, or a face detail map (TINY) feature,
wherein the at least one type of counterfeited clue information comprises any one or more of the following: 2D-type counterfeited clue information, 2.5D-type counterfeited clue information, or 3D-type counterfeited clue information.

11. The method according to claim 1, wherein before performing authentication on the extracted face features based on the stored face features, the method further comprises: obtaining the stored face features of face images of at least two different angles corresponding to the same ID through a face unlocking information registration process.

12. The method according to claim 11, wherein the face unlocking information registration process comprises:
outputting prompt information that indicates obtaining the face images of at least two different angles corresponding to the same ID;
performing face detection on the obtained images;
performing face feature extraction on the images in which the face at each angle of the at least two different angles is detected; and
storing the extracted face features of the face image of each angle, and a corresponding relationship between the same ID and the face features of the face image of each angle.

13. The method according to claim 12, wherein before performing face detection on the obtained image, the method further comprises: performing light equalization adjustment processing on the obtained image; and
the performing face detection on the obtained images comprises: performing face detection on an image subjected to the light equalization adjustment processing,
wherein before performing light equalization adjustment processing on the obtained image, the method further comprises: determining that the quality of the image does not satisfy the predetermined face detection condition.

14. The method according to claim 12, wherein before storing the extracted face features of the face image of each angle, the method further comprises:
detecting an angle of the face included in the image; and
determining that the detected angle matches an angle corresponding to the prompt information.

15. The method according to claim 14, wherein the detecting an angle of the face included in the image comprises:
performing face key point detection on the image; and
calculating the angle of the face in the image according to the detected face key points.

16. The method according to claim 12, further comprising:
performing living body detection on the image; and
in response to the image passing the living body detection, storing the extracted face features of the face image of each angle, and the corresponding relationship between the same ID and the face features of the face image of each angle.

17. The method according to claim 12, wherein after storing the extracted face features of the face image of each angle, the method further comprises:
identifying whether storing the face features of the face images of at least two different angles corresponding to the same ID is completed; and
in response to the storing the face images of at least two different angles corresponding to the same ID being not completed, outputting the prompt information that indicates obtaining of face images of at least two different angles corresponding to the same ID.

18. The method according to claim 17, further comprising: in response to the storing the face images of at least two different angles corresponding to the same ID being completed, outputting prompt information for prompting a user to input the same ID, wherein
the storing the extracted face features of the face image of each angle, and a corresponding relationship between the face features of the face image of each angle and the same ID comprises: storing the extracted face features of the face images of at least two angles and the same ID input by the user, and establishing a corresponding relationship between the same ID and the face features of the face images of at least two angles.

19. A face unlocking apparatus, comprising:
a processor; and
a memory for storing instructions executed by the processor,
wherein the processor is configured to:
perform face detection on one or more images;
perform face feature extraction on an image in which a face is detected;
perform authentication on extracted face features based on stored face features, wherein the stored face features at least comprise face features of face images of at least two different angles corresponding to a same identity (ID); and
perform an unlocking operation at least in response to the extracted face features passing the authentication.

20. A non-transitory computer-readable medium having stored thereon computer-readable instructions that, when being executed, implements operations of:
performing face detection on one or more images;
performing face feature extraction on an image in which a face is detected;
performing authentication on extracted face features based on stored face features, wherein the stored face features at least comprise face features of face images of at least two different angles corresponding to a same identity (ID); and
performing an unlocking operation at least in response to the extracted face features passing the authentication.
